(19) United States
(12) Patent Application Publication
(10) Pub. No.: US 2008/0308364 A1
(43) Pub. Date: Dec. 18, 2008

(54) Lightweight brake drum with middle position squealer band

(75) Inventors: Sik-Kan Huang, Albertville, AL (US); Christopher G. Ramsden, Hartselle, AL (US)

Correspondence Address: LANIER FORD SHAVER & PAYNE P.C., P O BOX 2087, HUNTSVILLE, AL, 35804-2087, US

(73) Assignee: Webb Wheel Products, Inc., Cullman, AL (US)

(21) Appl. No.: 11/818,033

(22) Filed: Jun. 13, 2007

(51) Int. Cl. F16D 65/10

(52) U.S. Cl. 188/218 R

(57) ABSTRACT

A novel brake drum includes one or more mid-positioned squealer bands that are roughly in line with the ribs of the brake shoes. This places the most rigid part of the brake drum and the location of greatest heat sink over the most rigid portion of the brake shoes, which is also the position of greatest heat input. The axial cooling fins radiating from the squealer band aid in dissipating the heat from friction generated during the braking cycle.

### BACKGROUND

1. Field

The present invention is related to brake drums, and more particularly, brake drums for heavy-duty commercial vehicles having reduced weight without the loss of required braking performance and drum integrity.

2. Description of the Related Art

Like most components for heavy-duty commercial vehicles such as truck as buses, the user desires the lowest amount of weight in the vehicle while obtaining the highest amount of performance. A standard full cast brake drum weigh approximately 112 pounds, while prior composite brake drums weigh approximately 92 pounds. Brake drums can only be lightened so much before performance suffers caused by lack of structural strength, heat absorption, and thermal fatigue from the friction of the brake lining.

One example of prior art attempts to lighten brake drums includes composite brake drums that contain a steel shell with gray iron centrifugally cast into the steel shell. The steel shell provides the structural strength to prevent cracking, and the gray iron liner provides the wear surface for the brake lining and heat absorption from the friction of the brake lining due to braking of the vehicle. The current shape of the composite brake drum is similar to conventional brake drum with the “squealer band” near the open end of the brake drum. Another prior art example is the “Gunite Gold” brake drum at 94 pounds. This brake drum uses high molybdenum content (>0.60%) and other alloys to provide strength at high braking temperatures. However, dynamometer tests show longer brake drum life at the expense of a higher tendency of brake fade with much lower deceleration at or above 60 miles per hour.

The purpose of a brake drum is to absorb the kinetic energy and potential energy of the vehicle into heat energy in the brake drum, resist the forces exerted by the brake shoes in stopping a vehicle, and transmit the braking torque to the wheels and tires of the vehicle. It is also the goal to accomplish this with components as light and cost effective as possible while maintaining the safe and effective operation of the braking system.

It is the intent of the invention to improve the absorption of heat energy and resist the forces exerted by the brake shoes in a more efficient manner by moving the squealer band over the center of the brake shoes, which is the point of maximum force and maximum heat input. It is a further goal to minimize metal fatigue and brake fade based on the temperature of the brake drum while in use.

### SUMMARY

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

The inventive brake drum obtains improved performance by positioning the squealer band in line with the ribs of the brake shoes. This places the most rigid part of the brake drum and the location of greatest heat sink over the most rigid portion of the brake shoes, which is also the position of greatest heat input. The axial cooling fins radiating from the squealer band aid in dissipating the heat from friction generated during the braking cycle.

### BRIEF DESCRIPTION OF THE DRAWINGS

The present invention is described with reference to the accompanying drawings. In the drawings, like reference numbers indicate identical or functionally similar elements.

FIG. 1 is an outboard perspective view of a brake drum with a squealer band located at a middle position along the width of the brake drum;

FIG. 2A is a section view of a brake drum showing a single squealer band located on the brake drum so that it is in line with the outboard rib of the brake shoe;

FIG. 2B is a section view of a brake drum showing a single squealer band located on the brake drum so that it is in line with the inboard rib of the brake shoe;

FIG. 3 is a section view of a brake drum showing a plurality of squealer bands located over each of a plurality of ribs of the brake shoe.

### DETAILED DESCRIPTION

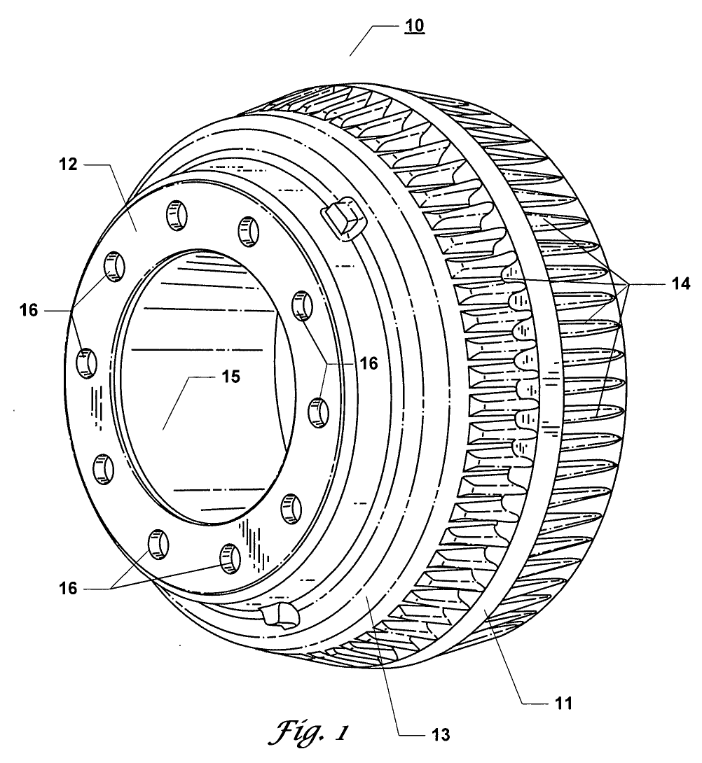

The various embodiments of the inventive brake drum and their advantages are best understood by referring to FIGS. 1 through 3 of the drawings. The elements of the drawings are not necessarily to scale, emphasis instead being placed upon clearly illustrating the principles of the invention.

The drawings represent and illustrate examples of the various embodiments of the brake drum, and not a limitation thereof. It will be apparent to those skilled in the art that various modifications and variations can be made in the brake drum described below without departing from the scope and spirit of the invention as described herein. For instance, features illustrated or described as part of one embodiment can be included in another embodiment to yield a still further embodiment. Moreover, variations in selection of materials and/or characteristics may be practiced to satisfy particular desired user criteria. Thus, it is intended that the present invention covers such modifications as come within the scope of the features and their equivalents.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment. Finally, as used in this description, terms such as “inboard” and “outboard” are to be understood as they relate to a vehicle on which the brake drum is mounted.

In one embodiment, an exemplary brake drum 10 comprises a brake surface 15 made from cast iron or other friction and wear resistant material, a mounting plate 12 at the brake drum's outboard end with mounting holes 16 for mounting the drum to the hub of a vehicle axle, a wraparound, or shoulder portion 13, and one or more squealer bands 11 circumscribing the brake drum. A brake drum is typically used with a brake shoe 21, an exemplary version of which consists of a brake lining 17 that is mounted on a brake shoe table 18. The brake shoe table 18 has one or more ribs 19 extending radially inwardly with respect to the brake drum from the table toward the interior of the drum to provide rigid support for the brake shoe table 18 and support for attachment points for a brake strut (not shown). In operation, the shoe 21 and brake lining 17 is selectively applied to the braking surface of the brake drum 10 through actuation of the brake through the rib or ribs 19 of the brake shoe 21. Brake drum 10 converts kinetic energy and potential energy of the vehicle into heat energy by providing a friction surface for the brake linings 17 thereby transmitting brake torque to the wheels and tires of the vehicle.

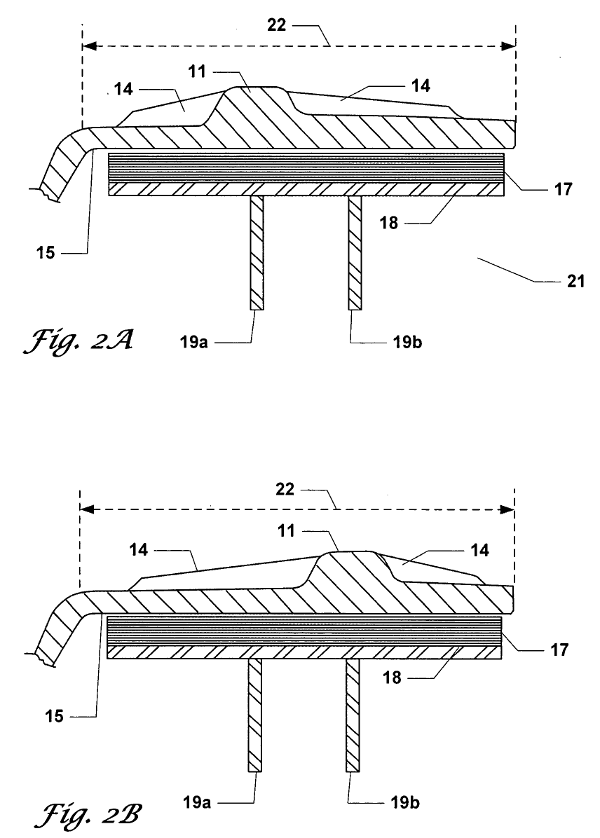

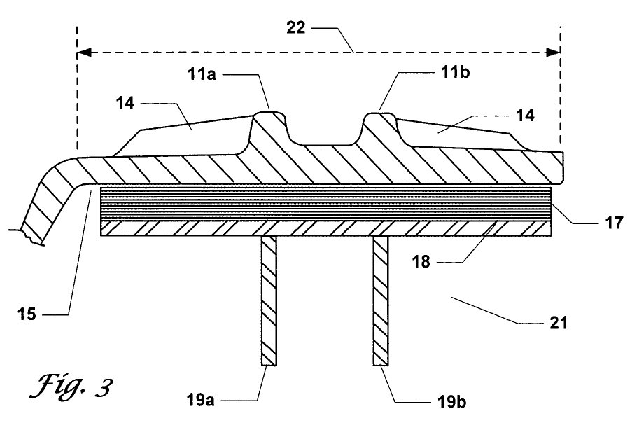

The main body of the brake drum 10 includes a squealer band 11 that circumscribes the brake drum positioned along the width 22 of the drum body such that when mounted on a vehicle, it is roughly in line with a brake shoe rib 19 of the brake shoe table 18. For example, with reference to FIG. 2A, brake drum 10 is configured so that squealer band 11 is roughly in line with the outer brake shoe rib 19a. In another embodiment, shown in FIG. 2B, brake drum is configured with squealer band 11 roughly in line with the inner brake shoe rib 19b. On either side of the squealer band 11 are a plurality of axial fins or ribs 14. In still another embodiment, depicted in FIG. 3, each of a plurality of squealer bands 11a, b is positioned roughly in line with each of the respective brake shoe ribs 19a, b.

Typically, when a squealer band is used on a brake drum, it is positioned near the inboard, open end of the brake drum. One reason for a squealer band at the open end of the brake drum is to prevent cracks that may start at the open end and to provide rigidity at the open end of the brake drum. A squealer band located midway along the width of the drum body goes against this concept. While the heat generated by the friction of the brake lining is suppose to be evenly distributed along the braking surface of a brake drum, the heat input to a brake drum is greatest at the most rigid portion of the brake shoe, i.e., opposite the brake shoe rib 19, where the lining contact pressure is greatest. Positioning the squealer band 11 at the location of the greatest heat input provides the most efficient use of the brake drum material for a heat sink during the braking operation. Additionally, positioning the squealer band 11 in line with the brake shoe ribs 19 sets the most rigid part of the brake drum to receive the most force from the brake shoe, and, therefore, provides the most efficient use of structure to resist the forces exerted by the brake shoes when they are applied to the braking surface.

As described above and shown in the associated drawings, the present invention comprises a lightweight brake drum with middle position squealer band. While particular embodiments of the invention have been described, it will be understood, however, that the invention is not limited thereto, since modifications may be made by those skilled in the art, particularly in light of the foregoing teachings. It is, therefore, contemplated by the following claims to cover any such modifications that incorporate those features or those improvements that embody the spirit and scope of the present invention.

We claim:

1. A brake drum for a vehicle braking system having one or more brake shoes that are configured with one or more attachment ribs and operable to be applied to the inner braking surface of said brake drum, said brake drum comprising a drum body having a width between inboard and outboard ends and at least one squealer band circumscribing the drum body disposed generally midway along the drum width such that when the brake drum is mounted within the braking system said at least one squealer band is roughly in line with at least one attachment rib.

2. The brake drum of claim 1, wherein the brake shoe includes inboard and outboard attachment ribs and wherein said at least one squealer band is one squealer band and is roughly in line with one of said ribs.

3. The brake drum of claim 1, wherein said at least one squealer band is two or more squealer bands and are both roughly in line with two or more ribs.

4. The brake drum of claim 1, further comprising a plurality of axial fins extending from said at least one squealer band along the outer surface of the drum toward either end.

5. The brake drum of claim 4, wherein the brake shoe includes inboard and outboard attachment ribs and wherein said at least one squealer band is one squealer band and is roughly in line with one of said ribs.

6. The brake drum of claim 4, wherein said at least one squealer band is two or more squealer bands and are both roughly in line with two or more ribs.

7. A brake drum for a vehicle drum braking system comprising a generally annular body having inboard and outboard ends and an annular wall with an inner surface upon which a brake shoe configured with at least one radially inwardly extending rib is applied, said wall comprising a band of increased thickness defined by the inner surface to an outer surface of the body, said band circumscribing the body intermediate said ends in a region of the width that is radially co-linear with said at least one rib when said brake shoe is applied to said inner surface.

8. The brake drum of claim 7, wherein said at least one rib is two ribs, and said wall comprises two bands of increased thickness, and wherein each of said bands of thickness is disposed intermediate said ends in regions of the width that are radially co-linear with each of said two ribs.
